(19) United States
(12) Patent Application Publication
(10) Pub. No.: US 2013/0322662 A1
(43) Pub. Date: Dec. 5, 2013

(54) MEMS MICROPHONE MODULE

(71) Applicants: Hung-Jen Chen, Hsinchu City (TW); Chao-Ching Huang, Taichung City (TW); Kuan-Hsun Chiu, Taichung City (TW); Yung-Ta Chen, Taichung City (TW); Xian-Gen Liao, Taichung City (TW)

(72) Inventors: Hung-Jen Chen, Hsinchu City (TW); Chao-Ching Huang, Taichung City (TW); Kuan-Hsun Chiu, Taichung City (TW); Yung-Ta Chen, Taichung City (TW); Xian-Gen Liao, Taichung City (TW)

(73) Assignee: MERRY ELECTRONICS CO., LTD., TAICHUNG CITY (TW)

(21) Appl. No.: 13/486,074

(22) Filed: Jun. 1, 2012

(51) Int. Cl. H04R 19/04

(52) U.S. Cl. 381/174

(57) ABSTRACT

A MEMS microphone module includes a substrate and a conducting lid covered on the substrate to define a chamber therebetween for accommodation of a MEMS chip and an ASIC chip. A ground layer of the substrate is electrically coupled to a protrusion of the conductive lid to form an EMI shielding structure. By this way, an EMI shielding effect can be applied by the EMI shielding structure to the MEMS chip and the ASIC chip.

### BACKGROUND OF THE INVENTION

1. Field of the Invention The present invention relates generally to a micro-electro-mechanical system (hereinafter referred to as “MEMS”) microphone and more particularly, to a MEMS microphone module that has a simple structure and low manufacturing cost.

2. Description of the Related Art

With the advance of the science and the technology, MEMS microphones having great advantages of small size and powerful function have been widely developed and used. When the MEMS microphone is used to receive the external sounds, it may be easily interfered by external factors (such as electromagnetic waves) which may cause poor signal quality or errors, resulting in lower added value of electrical products equipped with the conventional MEMS microphone. Thus, how to enhance an electromagnetic interference (hereinafter referred to as “EMI”) shielding effect of the MEMS microphone is the most important concern for manufacturing industries.

Taiwan Patent No. 1299961 discloses a MEMS microphone and a method of manufacturing the same. The MEMS microphone includes a substrate and a lid covered on the substrate and having a third conducting layer electrically coupled to a second conducting layer, which is formed of a conductive sliver glue, of the substrate. Further, an EMI shielding structure is created by the electrical connection among a first conducting layer of a frame, the second conducting layer of the substrate, the third conducting layer of the lid, and a grounding device for providing an EMI shielding to an IC chip. However, this prior art design has a disadvantage of high material cost and needs to address a manufacturing challenge that the conductive sliver glue has to be contacted with both of the first and third conducting layers, resulting in increase of manufacturing cost.

Taiwan Patent Publication No. 201101851 discloses a MEMS acoustic sensor package. In the second embodiment of this prior art design, the upper and middle plates of the lid are attached to each other through an conductive adhesive, the middle plate of the lid and the support plate are attached to each other through an electrically insulating adhesive, and the lid and the support plate are electrically coupled to each other through an elastic sheet for providing an EMI shielding effect. However, it is difficult to control the dimension of the elastic sheet and the process of connecting the upper plate of the lid to the support plate is a little bit complicated, so that this prior art design has the disadvantage of high manufacturing cost.

### SUMMARY OF THE INVENTION

The present invention has been accomplished in view of the above-noted circumstances. It is therefore the primary objective of the present invention to provide a MEMS microphone module, which can simplify structure and reduce manufacturing cost.

To achieve the above-mentioned objective, the micro-electro-mechanical system (MEMS) microphone module provided by the present invention comprises a substrate, a MEMS chip mounted with the substrate, an application-specific integrated circuit (ASIC) chip mounted with the substrate and electrically coupled to the MEMS chip, and a conducting lid covered on the substrate to define a chamber therebetween for accommodation of the MEMS chip and the ASIC ship. The conducting lid has an acoustic hole communicated with the chamber and a protrusion at a bottom side thereof electrically coupled to a ground layer of the substrate to create an EMI shielding structure for applying an EMI shielding effect to the MEMS chip and the ASIC chip.

By means of this design, the MEMS microphone module of the present invention is assembled by the attachment of the substrate and the conducting lid, and provided with the EMI shielding structure by the electrical connection of the ground layer of the substrate and the protrusion of the conducting lid, such that the MEMS microphone module of the present invention can attain the purpose of simplifying the overall structure and reducing the manufacturing cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a cross-sectional view of a MEMS microphone module in accordance with a first embodiment of the present invention;

FIG. 2 is a cross-sectional view of a MEMS microphone module in accordance with a second embodiment of the present invention;

FIG. 3 is a cross-sectional view of a MEMS microphone module in accordance with a third embodiment of the present invention; and

FIG. 4 is a cross-sectional view of a MEMS microphone module in accordance with a forth embodiment of the present invention.

### DETAILED DESCRIPTION OF THE INVENTION

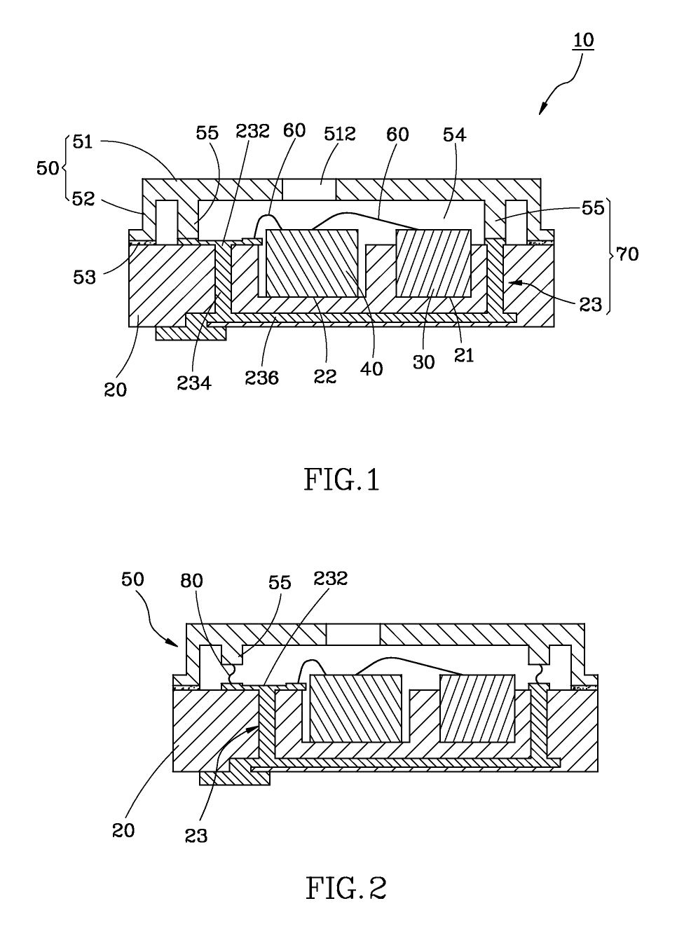

Referring to FIG. 1, a micro-electro-mechanical system (MEMS) microphone module 10 provided by a first embodiment of the present invention comprises a substrate 20, a MEMS chip 30, an application-specific integrated circuit (hereinafter referred to as “ASIC”) chip 40, and a conducting lid 50.

The substrate 20 has a first concavity 21 at the top side thereof, a second concavity 22 at the top side thereof spaced from the first concavity 21, and a ground layer 23. The ground layer 23 has a first section 232 arranged at the top side of the substrate 20, a second section 234 connected with the first section 232 and vertically arranged inside the substrate 20, and a third section 236 connected with the second section 234 and horizontally arranged inside the substrate 20.

The MEMS chip 30 and the ASIC chip 40 are disposed in the first and second concavities 21 and 22 of the substrate 20. The ASIC chip 40 is electrically coupled to the first section 232 of the ground layer 23 of the substrate 20 and the MEMS chip 30 through two wires 60 respectively.

The conducting lid 50 is made of metal, including a top wall 51 and a lateral wall 52 extending from a periphery of the top wall 51 and attached to the top side of the substrate 20 through an adhesive 53 (such as an insulating adhesive or conductive adhesive), such that a chamber 54 is define between the conducting lid 50 and the substrate 20 for accommodation of the MEMS chip 30 and the ASIC chip 40. An acoustic hole 512 is provided at the top wall 51 of the conducting lid 50 and communicated with the outsides for enabling the MEMS chip 30 to receive the external sounds therethrough. Further, a protrusion 55 extends integrally from the bottom side of the top wall 51 of the conducting lid 50 and is electrically contacted with the first section 232 of the ground layer 23 of the substrate 20, such that an EMI shielding structure 70 is created by the electrical connection of the protrusion 55 of the conducting lid 50 and the ground layer 23 of the substrate 20 for providing an EMI shielding effect to the MEMS chip 30 and the ASIC chip 40.

To deserve to be mentioned, if the insulating adhesive is used between the substrate 20 and the conducting lid 50, the conducting lid 50 and the substrate 20 are electrically coupled to each other through the contact between the protrusion 55 of the conducting lid 50 and the ground layer 23 of the substrate 20. On the other hand, if the conductive adhesive is used between the substrate 20 and the conducting lid 50, the electrical connection (especially in ground connection) between the conducting lid 50 and the substrate 20 can be ensured by the contact between the protrusion 55 of the conducting lid 50 and the ground layer 23 of the substrate 20. Besides, the protrusion 55 of the conducting lid 50 can be electrically coupled to the ground layer 23 of the substrate 20 through a conductive adhesive for ensuring the electrical connection between the protrusion 55 and the ground layer 23.

When compared with the conducting member (such as the conductive sliver glue or the elastic sheet) of the prior art design, the MEMS microphone module 10 of the present invention has a relatively simpler structure adopting the cooperation of the ground layer 23 of the substrate 20 and the protrusion 55 of the conducting lid 50 to offer the desired EMI shielding effect. Further, as stated above, the conductive adhesive can be used between the ground layer 23 of the substrate 20 and the protrusion 55 of the conducting lid 50 if the protrusion 55 is not long enough to touch the ground layer 23. Accordingly, the MEMS microphone module 10 of the present invention has the advantage of simplifying overall structure and reducing manufacturing cost.

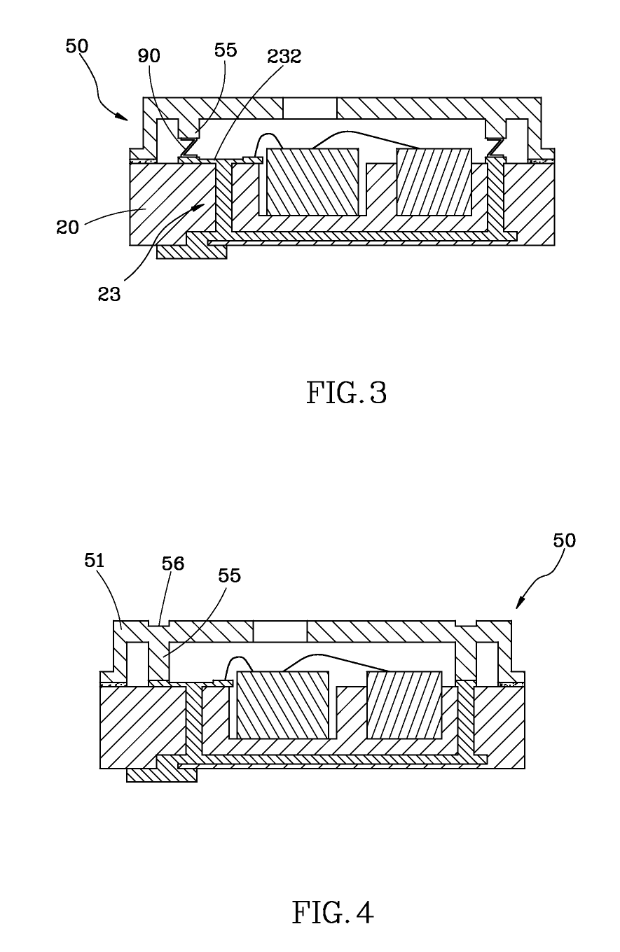

To deserve to be mentioned, the protrusion 55 of the conducting lid 50 can be electrically coupled to the ground layer 23 of the substrate 20 through a conducting member, such as a metal wire 80 shown in FIG. 2 or a metal elastic sheet 90 shown in FIG. 3, for creating the EMI shielding structure 70. Further, as shown in FIG. 4, the protrusion 55 can be forced to protrude from the bottom side of the top wall 51 of the conducting lid 50 by stamping process or other processes, and therefore a recess 56 will be formed at the top side of the conducting lid 50 and arranged opposite to the protrusion 55.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A MEMS microphone module comprising:
a substrate having a ground layer;
a MEMS chip mounted with the substrate;
an ASIC chip mounted with the substrate and electrically coupled to the MEMS chip; and
a conducting lid covered on the substrate to define a chamber therebetween for accommodation of the MEMS chip and the ASIC ship, the conducting lid having an acoustic hole communicated with the chamber and a protrusion at a bottom side thereof electrically coupled to the ground layer of the substrate to create an EMI shielding structure for providing an EMI shielding effect to the MEMS chip and the ASIC chip.

2. The MEMS microphone module of claim 1, wherein the substrate includes a first concavity for installation of the MEMS chip, and a second concavity spaced from the first concavity for installation of the ASIC chip.

3. The MEMS microphone module of claim 1, wherein the conducting lid has a top wall with the acoustic hole, and a lateral wall extending from a periphery of the top wall and attached to the substrate through an adhesive.

4. The MEMS microphone module of claim 3, wherein the adhesive is an insulating adhesive or a conductive adhesive.

5. The MEMS microphone module of claim 1, wherein the ASIC chip is electrically coupled to the ground layer of the substrate through a wire and electrically coupled to the MEMS chip through a wire.

6. The MEMS microphone module of claim 1, wherein the conducting lid forming the protrusion by stamping process, and a top side of the conducting lid has a recess arranged opposite to the protrusion.

7. The MEMS microphone module of claim 1, wherein the protrusion of the conducting lid is electrically and directly contacted with the ground layer of the substrate.

8. The MEMS microphone module of claim 1, wherein the protrusion of the conducting lid is electrically coupled to the ground layer of the substrate through a conducting member.

9. The MEMS microphone module of claim 8, wherein the conducting member is a metal wire or a metal elastic sheet.

10. The MEMS microphone module of claim 1, wherein the protrusion of the conducting lid is electrically coupled to the ground layer of the substrate through a conductive adhesive.
